(19) United States
(12) Patent Application Publication
(10) Pub. No.: US 2006/0250745 A1
(43) Pub. Date: Nov. 9, 2006

(54) PROGRAMMABLE POWER CONTROLLER

(76) Inventors: Alan Butler, Alpharetta, GA (US); Jeffrey Smith, Alpharetta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/381,916

(22) Filed: May 5, 2006

Related U.S. Application Data
(60) Provisional application No. 60/678,109, filed on May 5, 2005.

(51) Int. Cl. H01H 47/00

(52) U.S. Cl. 361/160

(57) ABSTRACT

A device connected between a source of power and at least one load for selectively providing power from the source of power to the at least one load to operate in an area responsive to an environmental condition in the area. In one embodiment, the device includes a home mode, an away mode, and a custom mode, and a user interface for selecting one of the home mode and the custom mode to be operated. The device further includes at least one timer for timing a plurality of predefined operations, a first detector for generating a low light detection signal responsive to an ambient light level being below a predetermined threshold value, a second detector for generating a motion signal responsive to detection of a movement in the area, a dimmer for adjusting power supplying to the at least one load at a predetermined level, and a microcontroller coupled to the first detector and the second detector and coupled with the user interface for operatively controlling transmission of the source of power to the at least one load.

### CROSS-REFERENCE TO RELATED PATENT APPLICATION

This application claims the benefit, pursuant to 35 U.S.C. §119(e), of U.S. provisional patent application Ser. No. 60/678,109 filed May 5, 2005, entitled “PROGRAMMABLE POWER CONTROLLER” by Alan Butler and Jeffrey Smith, which is incorporated herein by reference in its entirety.

### FIELD OF THE INVENTION

The present invention generally relates to a power controller, and more particularly, to a programmable power controller connected between a source of power and at least one load for selectively providing power from the source of power to the at least one load to operate in an area thereof responsive to an environmental condition in the area.

### BACKGROUND OF THE INVENTION

As a result of dramatically increasing costs associated with electrical energy, devices have been developed that automatically activate and deactivate electrical appliances such as lights depending on when they are needed. The most rudimentary devices comprise a timer that automatically activates and deactivates the appliances at predetermined time intervals. More sophisticated devices include a motion detector that can sense when a person is present in a specified area so as to trigger the activation and deactivation of appliances accordingly. Other devices include the dusk to dawn control systems, which are configured to turn lights on and off solely based upon the amount of sunlight present.

For the motion sensor based devices, however, there may be significant amounts of normal activity during the day time which would undesirably activate the lighting system which the motion detector is controlling.

Controlling a lighting system based on the amount of sunlight present has disadvantages based upon energy usage. Since the illuminated area will remain illuminated all night, the energy consumption is greater than that which would be required for an illumination period lasting from one third to one half of the night time. Another problem with controlled lighting systems is the effort required to override the timed, dusk to dawn, and motion detection controls. The user usually is forced to approach the timer box that may be remotely located from the light switch. The timer must be tripped, reset, or disabled, depending upon its configuration.

On the other hand, few of these conventional power control devices are programmable.

Therefore, a heretofore unaddressed need exists in the art to address the aforementioned deficiencies and inadequacies.

### SUMMARY OF THE INVENTION

The above-mentioned disadvantages of the prior art are overcome by the present invention, which in one aspect is a device connected between a source of power and at least one load for selectively providing power from the source of power to the at least one load to operate in an area thereof responsive to an environmental condition in the area. The environmental conditions in the area include various events, such as an ambient light level being below a predetermined threshold value, detected movement in the area, and expiration of a predetermined power-on time period.

According to one aspect of the invention, there is provided a device for selectively providing power from a source of power to an electrical load in response to detected environmental conditions in an area. The device comprises a programmed microcontroller, an electronic switch coupled to the microcontroller for switching power to the load at variable levels (for example, for illuminating a light at varying levels of brightness) in response to signals from the microcontroller, a light detector coupled to the microcontroller operative to detect ambient light level in the area, and a motion detector coupled to the microcontroller operative to detect motion in the area. The microcontroller is operative to switch power to the load at a predetermined partial level in response to detection by the light detector of ambient light at a predetermined level in the area. The microcontroller is further operative to switch power to the load at a predetermined higher level in response to detection of motion in the area by the motion detector. The microcontroller is still further operative to maintain a timer that causes the device to maintain power to the load at the higher level for a predetermined time period in response to detection of further motion in the area by the motion detector. Further still, the microcontroller is operative to switch power to the load back to the predetermined partial level in response to expiration of the timer without retriggering by detection of further motion. Finally, the microcontroller is operative to switch power to the load off in response to a predetermined off time, notwithstanding the ambient light level.

In one embodiment of the present invention, the device includes a home mode, an away mode, and a custom mode. In the home mode, the device operates such that a plurality of control parameters are pre-programmed and preset in the device, for example, in the manner as described in the preceding paragraph. In the away mode, the device is configured for turning on and off the device at random times. In the custom mode, the user enters the desired settings of the plurality of control parameters and then initiates the changes via a user interface. The plurality of control parameters includes the predetermined threshold value, and one or more predetermined activation times, one or more predetermined deactivation times, and/or one or more other durations of time. Specifically, the predetermined times may include a first predetermined activation time, a second predetermined activation time, a first predetermined deactivation time, a second predetermined deactivation time, a first predetermined duration of time, a second predetermined duration of time, a third predetermined duration of time, and a predetermined power-on time.

Furthermore, the device includes a user interface for selecting one of the home mode and the custom mode to be operated. The user interface has a plurality of pushbuttons and at least one display for displaying menus with selectable items or commands. Each pushbutton performs a predetermined function, and each menu is associated with the plurality of pushbuttons. The display is preferably a liquid crystal display (“LCD”) or a light emitting diode (“LED”) display.

Moreover, the device includes at least one timer for timing a plurality of predefined operations, a first detector for generating a detection signal responsive to an ambient light level being below a predetermined threshold value (e.g. a “low light” signal), a second detector for generating a motion signal responsive to detection of a movement in the area, and a microcontroller coupled to the first detector and the second detector and coupled to the user interface for operatively controlling transmission of the source of power to the at least one load.

The first detector is preferably a light sensor, for example, a photocell, and will be activated to monitor the ambient light level (detect a low light level, for example) when the first predetermined activation time passes, and will be deactivated when the first predetermined deactivation time passes. The second detector is preferably a motion sensor, such as pyroelectric passive infrared (hereinafter “PIR”) sensor, and will be activated to monitor the movement in the area when the second predetermined activation time passes, and will be deactivated when the second predetermined deactivation time passes. The microcontroller is configured such that when one of the detection signal and the motion signal is generated or the predetermined power-on time passes, the device will transmit the power to the at least one load for a time period, where the time period is defined by the first predetermined duration of time if the triggering signal is the detection signal, by the second predetermined duration of time if the triggering signal is the motion signal, or by the third predetermined duration of time if the predetermined power-on time passes.

Additionally, the device includes a manual mode having an ON state and an OFF state. In the manual mode, the device operates like a switch. The ON state corresponds to the switch-on state of the switch, which allows the power to pass through the device to the at least one load regardless of the environmental condition in the area, while the OFF state corresponds to the switch-off state of the switch, which does not allow the power to pass through to the load regardless of the environmental condition in the area.

In another aspect, the present invention relates to a device connected between a source of power and at least one load for selectively providing power from the source of power to the at least one load to operate in an area. In one embodiment, the device includes at least one timer for timing a plurality of predefined operations, a first detector for generating a detection signal responsive to an ambient light level being below a predetermined threshold value (e.g. a low light environmental condition), a second detector for generating a motion signal responsive to detection of a movement in the area, a microcontroller coupled to the first detector and the second detector for operatively controlling transmission of the source of power to the at least one load, and a user interface in communication with the microcontroller for programmably configuring a plurality of control parameters. The plurality of control parameters includes the predetermined threshold value, the first predetermined activation time, the second predetermined activation time, the first predetermined deactivation time, the second predetermined deactivation time, the first predetermined duration of time, the second predetermined duration of time, the third predetermined duration of time, and the predetermined power-on time.

In one embodiment, the first detector is a light sensor, for example, a photocell, and will be activated to monitor the ambient light level (e.g. low light level) when the first predetermined activation time passes, and will be deactivated when the first predetermined deactivation time passes. The second detector is a motion sensor, such as PIR sensor, and will be activated to monitor the movement in the area when the second predetermined activation time passes, and will be deactivated when the second predetermined deactivation time passes.

According to an aspect of the invention, the microcontroller is preferably configured such that when one of the detection signal and the motion signal is generated or the predetermined power-on time passes, the device will transmit the power to the at least one load for a time period, where the time period is defined by the first predetermined duration of time if the triggering signal is the detection signal, by the second predetermined duration of time if the triggering signal is the motion signal, or by the third predetermined duration of time if the predetermined power-on time passes. Furthermore, when transmitting the power is triggered by the detection signal, any subsequent one of a motion signal or expiration of the predetermined power-on time period generated during the time period defined by the first predetermined duration of time is ignored. Further still, when transmitting the power is triggered by the expiration of the predetermined power-on time period, any subsequent one of a low light detection signal or a motion signal generated during the third predetermined duration of time is ignored. And further still, when transmitting the power is triggered by the motion signal, any subsequent one of a low light detection signal or expiration of the predetermined power-on time period generated during the second predetermined duration of time is ignored, but a subsequent motion signal generated by the second detector during the time period triggers renewal of the time period.

In one embodiment, the user interface has a plurality of pushbuttons and a display for displaying menus of selectable items or commands. Each pushbutton performs a predetermined function, and each menu is associated with the plurality of pushbuttons. The display is an LCD or an LED display.

In another embodiment, the user interface has a touch screen having a plurality of settings. Each setting includes icons, each icon corresponding to a predetermined function that is communicated to the microcontroller to cause the device to perform a predefined operation. The touch screen is an LCD or an LED display.

In yet another aspect, the present invention relates to a method for selectively providing power from a source of power to at least one load to operate in an area in response to plural environmental conditions and time periods. In one embodiment, the method includes the step of configuring a first detector for generating a detection signal responsive to an ambient light level being below the predetermined threshold value (e.g. a low light level), a second detector for generating a motion signal responsive to a movement in the area, and a microcontroller coupled to the first detector and the second detector for operatively controlling transmission of the source of power to the at least one load. The method further includes the step of programming a plurality of control parameters with a user interface communicating with a microcontroller. The plurality of control parameters comprises a predetermined threshold value of a light level, a first predetermined activation time, a second predetermined activation time, a first predetermined deactivation time, a second predetermined deactivation time, a first predetermined duration of time, a second predetermined duration of time, a third predetermined duration of time, and a predetermined power-on time. Moreover, the method includes the step of activating the first detector to monitor an ambient light level when the first predetermined activation time passes, and the second detector to monitor a movement in the area when the second predetermined activation time passes. Furthermore, the method includes the step of transmitting the power to the at least one load for a time period by a microcontroller when one of the detection signal and the motion signal is generated or the predetermined power-on time passes. The time period is defined by the first predetermined duration of time if the triggering signal is the detection signal, by the second predetermined duration of time if the triggering signal is the motion signal, or by the third predetermined duration of time if the predetermined power-on time passes. Additionally, the method includes the step of deactivating the first detector when the first predetermined deactivation time passes, and the second detector when the second predetermined deactivation time passes.

In one embodiment, the microcontroller is further configured such that when transmitting the power is triggered by the low light detection signal, any subsequent one a motion signal or expiration of the predetermined power-on time period generated during the first predetermined duration of time is ignored. Furthermore, when transmitting the power is triggered by the expiration of the predetermined power-on time period, any subsequent one of a low light detection signal or a motion signal generated during the third predetermined duration of time is ignored. Further still, when transmitting the power is triggered by the motion signal, any subsequent one of a low light detection signal or expiration of the predetermined power-on time period generated during the second predetermined duration of time is ignored, but a subsequent motion signal generated by the second detector during the time period renews the time period.

In one embodiment, the first detector includes a light sensor. The light sensor is a photocell. The second detector includes a motion sensor, which is a PIR sensor module, for example. The user interface has a touch screen having a plurality of settings, each setting including icons, each corresponding to a predetermined function that is communicated to the microcontroller to cause the device to perform a predefined operation.

In a further aspect, the present invention relates to a device connected between a source of power and at least one load for selectively providing power from the source of power to the at least one load to operate in an area responsive to an environmental condition in the area. The environmental condition in the area has a plurality of events including an ambient light level being below a predetermined threshold value, a movement in the area, and expiration of a predetermined power-on time period.

In one embodiment, the device has a home mode. The home mode is configured to allow the device to operate such that a plurality of functions are pre-programmed. For example, such pre-programmed functions include the following: (1) when the ambient light level is above a predetermined threshold value, the device is powered off, and a detected signal of motion will trigger the device to be power on with a full amount of power for a predetermined period of time; thereafter, the device is powered off if no motion is detected during the predetermined period of time; and (2) when the ambient light level is below the predetermined threshold value, the device is power on with a predetermined reduced amount of power, and a detected signal of a motion will trigger the device to be power on with a full amount of power for a first predetermined period of time; if no further motion is detected during the first predetermined period of time, the device reduces power to the predetermined reduced amount of power for a second predetermined period of time; and if no further motion is detected during the second predetermined period of time, the device is powered off.

In one embodiment, the home mode is further configured such that when the ambient light level is above the predetermined threshold value, the device is powered off and movement in the area is ignored.

The device preferably further has a pre-programmed away mode that is configured such that if the ambient light level is below the predetermined threshold value, the device is powered on and off at random times. Further still, the device preferably has a custom mode that is configured for allowing the device to operate in a way of which a plurality of functions are programmable.

Moreover, the device has a dimmer for adjusting output power of the at least one load at a predetermined level. Additionally, the device has a user interface for selectively operating the device in one of the home mode, the away mode, and the custom mode.

In yet a further aspect, the present invention relates to a device connected between a source of power and at least one load for selectively providing power from the source of power to the at least one load to operate in an area. In one embodiment, the device includes a dimmer for adjusting the power supplying to the at least one load and is responsive to an environmental condition in the area, where the environmental condition in the area comprises a plurality of events including an ambient light level being below a predetermined threshold value, movement in the area, and expiration of a predetermined power-on time period.

The device further includes a photodetector for generating a detection signal responsive to an ambient light level being below a predetermined threshold value in the area.

The device also includes a motion detector for generating a motion signal responsive to detection of a movement in the area.

Furthermore, the device of claim includes a microcontroller coupled to the dimmer, the photo detector and the motion detector for programmably controlling transmission of the source of power to the at least one load responsive to the detection signal and the motion signal.

These and other aspects will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows a device according to one embodiment of the present invention including a user interface for configuring the device.

FIG. 2 shows steps for configuring the device as shown in FIG. 1 according to one embodiment of the invention.

FIG. 3 shows schematically a device according to another embodiment of the present invention including a user interface for configuring the device.

FIG. 4, consisting of FIGS. 4A-4D, shows steps for configuring the device as shown in FIG. 3.

FIG. 5 shows a circuit diagram of a device according to one embodiment of the present invention.

FIG. 6 shows a flowchart of a timer in operation according to one embodiment of the present invention.

FIG. 7 shows a flowchart of a photocell in operation according to one embodiment of the present invention.

FIG. 8 shows a flowchart of a motion sensor in operation according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

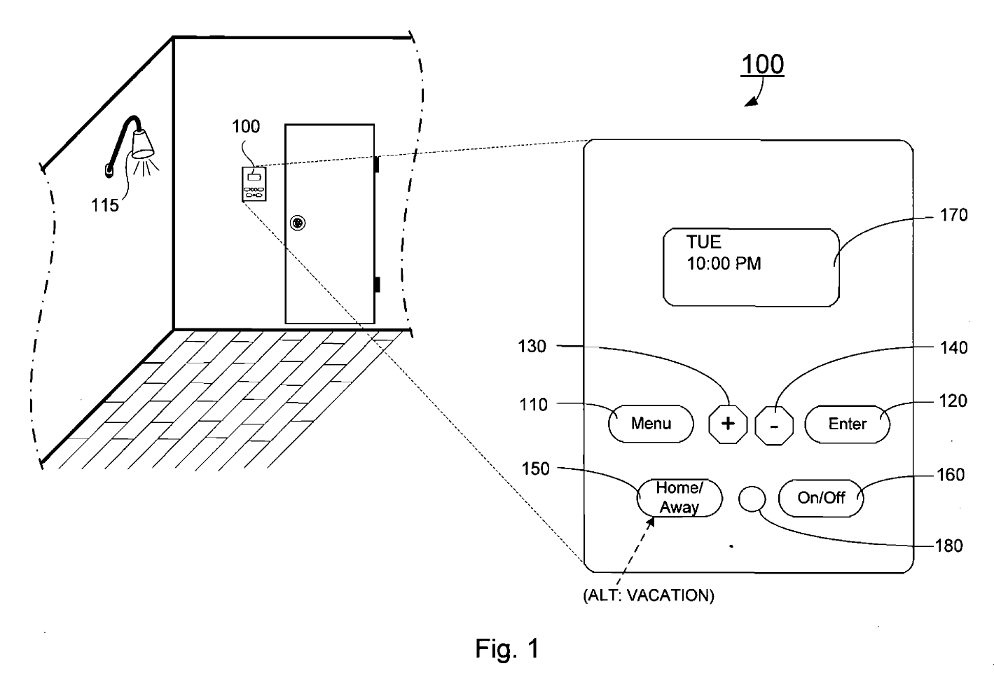

The description will be made as to the embodiments of the present invention in conjunction with the accompanying drawings of FIGS. 1-8. In accordance with the purposes of this invention, as embodied and broadly described herein, this invention, in one aspect, relates to a device connected between a source of power and at least one load for selectively providing power from the source of power to the at least one load to operate in an area and responsive to an environmental condition in the area. The environmental condition in the area includes various events, such as an ambient light level being below a predetermined threshold value, detected movement in the area, and expiration of a predetermined power-on time period. The at least one load in one embodiment includes the light installed in the area.

In one embodiment of the present invention, the device includes a home mode and a custom mode. In the custom mode, the user can enter the desired settings of the plurality of control parameters and then initiates the changes via the user interface. The plurality of control parameters includes the predetermined threshold value, a first predetermined activation time, a second predetermined activation time, a first predetermined deactivation time, a second predetermined deactivation time, a first predetermined duration of time, a second predetermined duration of time, a third predetermined duration of time, and a predetermined power-on time. In the home mode, the device operates such that a plurality of control parameters are pre-programmed and preset in the device. For example, during day light, the device is powered off until it detects motion, then it is power on for a predetermined period of time. At dark, the device turns on the light at a predetermined reduced amount of power (e.g. dimmed to a certain level). In this situation, if motion is detected, it goes to the full power of the light; after a first predetermined period of time, it goes back to the predetermined (reduced) amount of power, and then after a second predetermined period of time the device turns off. In one embodiment, the predetermined amount of power is 50% of the full power of the light. The device further has an away mode that is configured such that the ambient light level is below the predetermined threshold value, the device is powered on and off at random times.

Moreover, the device includes at least one timer for timing a plurality of predefined operations, a first detector for generating a low light detection signal thereof responsive to an ambient light level being below a predetermined threshold value, a second detector for generating a motion signal thereof responsive to detection of movement in the area, and a microcontroller coupled to the first detector and the second detector and coupled to the user interface for operatively controlling transmission of the source of power to the at least one load. In one embodiment, the first detector is a light/photo sensor, for example, a photocell, the second detector is a motion sensor, such as PIR sensor.

The device also has a dimmer for adjusting output power of the at least one load at a predetermined level. Additionally, the device has a user interface for selectively operating the device in one of the home mode, the away mode, and the custom mode.

Without intent to limit the scope of the invention, these and other aspects of the present invention are more specifically described in the following exemplary embodiments. Note that names, geometric shapes and positions of pushbuttons used in the exemplary embodiments are for illustration of operation of the device and should not limit the scope of the invention. Moreover, the term “pushbutton” as used herein, refers to a protruded button or a touch area in a user interface of the device, which in no way should limit the scope of the invention.

Referring to FIG. 1, a device 100 is shown according to one embodiment of the present invention. The device 100 is especially adapted to connect to a source of AC electrical power (not shown) and switch the power on and off to an electrical load, such as an electrical light 115. Those skilled in the art will understand that electrical terminals (not shown) are provided for the device that allow connection of the source of electrical power to a first set of terminals, and connection of the electrical load to a second set of terminals. Preferably, the device 100 includes an electronically-controllable variable power switch (not shown in FIG. 1), well known to those skilled in the art, that controllably switches power to the electrical load at variable levels so as to provide a dimming function for incandescent and other types of lights that respond to variable AC power levels.

Although the device 100 is shown in FIG. 1 as sized and shaped for mounting in a conventional wall-mounted electrical junction box cut-out, those skilled in the art will understand and appreciate that the device may be configured as a stand-unit with a power cord and electrical out for receiving the electrical plug of a table lamp or other electrical load, or may be configured in a number of different manners.

The device 100 includes a user interface that plurality a plurality of pushbuttons including Menu 110, Enter 120, plus (+) 130, minus (−) 140, Home/Away 150, and On/Off 160, and a display 170 for displaying a menus of selectable commands during setting up the device and/or the current day and time in operation. For example, as shown in FIG. 1, the display 170 displays the current day: TUE, and the current time: 10:00 PM. Each pushbutton in the user interface is associated with a predetermined function. Pushing such a pushbutton causes the device to perform the predetermined function. Alternatively, the Home/Away button 150 might be labeled as a “Vacation” button, which would toggle operation between a preprogrammed state corresponding to a “home” mode when the user is in the area (and may want the light to come on at dusk and stay on or stay bright if triggered by the motion sensors, but may want the light to go out after a certain time in the evening unless motion is detected) and a different preprogrammed state corresponding to an “away” mode when the user is not expected to be in the area.

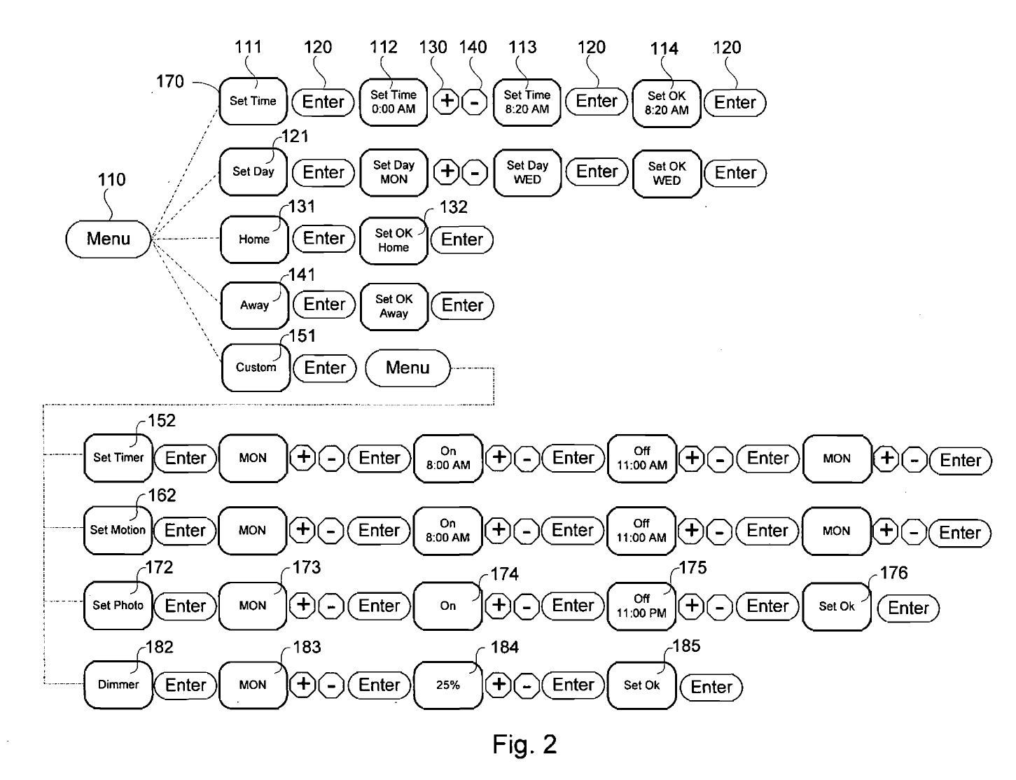

FIG. 2 shows certain setting-up or configuration procedures for the device 100. For example, sequentially pushing Menu 110 causes the device to perform a Menu function for scrolling through all menus, such as Set Time 111, Set Day 121, Home 131, Away 141, and Custom 151. The Enter button 120 is associated with an Enter function for entering the settings to be programmed. The plus and minus buttons (+/−) 130/140 are associated with a +/− (increment/decrement) function for scrolling through Set Time, Set Day, Set Timer, Set Motion, Set Photo and Dimmer as to change and/or select the setting parameters. Away 150 is associated with an away function for simulating an occupation of a monitored area when the occupant of the monitored property is away. And On/Off button 160 is associated with an On/Off function for operating the device in a manual mode. Additionally, each menu is associated with the plurality of pushbuttons. For example, Set Time 111 is associated with Menu 110, Enter 120, +130, −140. In one embodiment, display 170 is an LCD or an LED display. The device can be controlled locally through the user interface or remotely via a remote control.

In operation, pushes of the Menu button 110 allow a user to scroll through the following menus, as displayed on the display 170: Set Time 111, Set Day 121, Home 131, Away 141, and Custom 151. The user may then push Enter 120 to select a desired menu, for example, Set Time 111. By pushing +130 and/or −140, the user can change time from Set Time, for example, 0:00 AM 112, to a desired Set Time, for example, 8:20 AM 113. A subsequent push of the Enter button 120 will finish the change of time, i.e., Set OK 8:20 AM 114. To return to a next menu, push Enter 120 again. Similarly, a user can change Set Day to a desired day.

To set the device to operate in the home mode, a user can select menu Home 131 by pushing Menu 110. Then push Enter 120, the device will enter into the home mode. To return to a next menu, push Enter 120 again. Applying the same procedure, the user can set the device to operate in an away mode. Additionally, the away mode can also be set by pushing Home/Away 150 (alternatively labeled “Vacation”) in the user interface of the device 100. When the device operates in the away mode, a LED indicator 180 will be illuminated.

To set the device to operate in the custom mode, a user can select menu Custom 151 by pushing Menu 110 until Custom 151 is displayed in the display 170, then push Enter 120 to enter into menu Custom 151. Subsequent pushes of Menu 110 allow the user to scroll through the submenus, Set Timer 152, Set Motion 162, Set Photo 172 and Dimmer 182 for setting a plurality of predetermined control parameters. One example of setting up a photocell is: on the submenu 172, (1) push Enter 120 to display a day, Mon 173, for the day which the user wants to set for, (2) push +130 and/or −140 to change the day to a desired day of a week or all of a week, (3) push Enter 120 to initialize the change of day and enter into a next screen, On 8:00 AM 174, which is a first predetermined activation time for the photocell, (4) push +130 and/or −140 to change the time to a desired activation time, (5) push Enter 120 to initialize the change of the activation time and enter into a next screen, Off 11:00 PM 175, which is a first predetermined deactivation time for the photocell, (6) push +130 and/or −140 to change the time to a desired deactivation time, and (7) push Enter 120 to initialize the change of the deactivation time and enter into a next screen, Set OK 176, to finish the setting up for the photocell.

To change a predetermined threshold value of an environmental light level in a monitored area, the user can select menu Dimmer 182, then (1) push Enter 120 to display a day, Mon 183, for the day which the user wants to set for, (2) push +130 and/or −140 to change the day to a desired day of a week or all of a week, (3) push Enter 120 to initialize the change of day and enter into a next screen, 25% 184, which is the predetermined threshold value, (4) push +130 and/or −140 to change the value to a desired threshold value, and (5) push Enter 120 to initialize the change of the threshold value and enter into a next screen, Set OK 185, to finish the setting up for the predetermined threshold value.

Following the similar procedures, the motion sensor and the timer can be set up accordingly.

In another embodiment, the device includes a first timer and a second timer, Timer A and Timer B, a motion sensor, a photo sensor, and a dimmer. The device in use operates in one of a home mode, away mode, custom mode, and on/off mode.

In the on/off mode, the device operates manually to turn the light on or off. When the device operates in this mode, the first and second timers, photo sensor, motion sensor and dimmer are deactivated. The device operates like a conventional light switch in the on/off mode.

In the custom mode, the device is triggered if the activation times for the first timer and the second timer are set to be later than the current time, or the first timer and the second timer is set to be activated now. The light is output at a pre-programmed dimming level. If the first timer and the second timer overlap, the second timer takes precedence over the first timer. The light goes on only if the day of the week matches a pre-programmed day. The first and second timers do not operate if a home or away mode is set.

The motion sensor is activated according to the customized parameter settings. If motion is detected, the light is turned on at the pre-programmed dimming level for a predetermined time, for example, five minutes. If a subsequent motion is detected while the light is on, the timer associated with the motion sensor is reset to the predetermined time, e.g., five minutes. There is preferably about a ten second delay from the time that the light is shut off until the motion sensor is armed again. The motion sensor is activated only if the day of the week matches the pre-programmed day. In one aspect, the motion sensor does not operate in a home or away mode.

The photo sensor is activated according to the customized parameter settings. If the ambient light level below a predetermined level is detected, the light is turned on at the pre-programmed dimming level until the power-off time. The photo sensor is activated only if the day of the week matches the programmed day. The photo sensor will not operate if a home or away mode is set.

In the home mode, in one embodiment, if the device detects the ambient light level being below the pre-determined level between, for example, 7:00 PM and 12:00 AM of a day, the light is turned on at a 50% of a pre-determined dimming level. If a motion is detected during a period of time, the light comes on at the 100% of the pre-determined dimming level for a predetermined period of time, e.g., about five minutes. Afterwards, the light returns to the 50% of the pre-determined dimming level and the motion sensor is activated.

In the away mode, in one embodiment, if the device detects the ambient light level being below the pre-determined level between, for example, 7:00 PM and 12:00 AM of a day, the light is turned on for random periods of time (between 5 and 30 minutes) at random dimming level, for example, 100% or 75%. In between, the light is turned off. During the periods of dark, the LED on the device is on to show that the away mode is active. If Timer A or Timer B is active, the away mode will not start until the timer program is over.

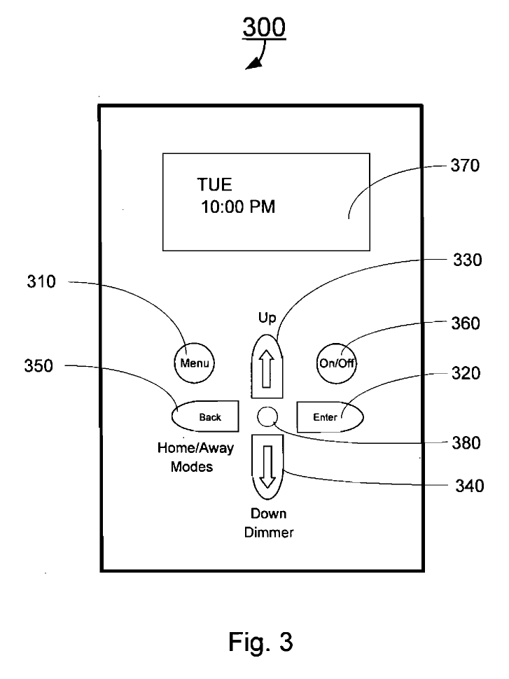

FIG. 3 shows another embodiment of a device 300 according to an aspect of the invention, also including a user interface as with the embodiment 100. As with the device 100, the device 300 is operable and programmable through a user interface of the device. The user interface 300 has a plurality of pushbuttons including Menu 310, Enter 320, Down 340, Up 330, Back 350, and On/Off 360, an LED indicator 380, and a display 370 for displaying a time, a day and a flow of menus. Each pushbutton performs a predetermined function. For example, while the time and day are displayed on the display 370, Menu 310 is used to access Custom sub-menu. On/Off 360 is used to turn the light on or off. Pressing the On/Off button 360 cancels all activated timers and clears the Home and Away modes. Any custom triggers and timers that happen will be ignored if the light is on. The LED 380 is on when the device is turned on with the On/Off switch 360, which includes when the dimming level is set to 0% to remind the user that the device has been turned on even though no power is being supplied to the light. Up 330 and Down 340 are adapted for adjusting a dimming level of the light, which will be displayed on the display 370.

In one embodiment, after about 3 seconds of not pressing the Up 330 and/or Down 340, the display 370 reverts to display the time and the day. The first press of the Up 330 and/or Down 340 causes the display 370 to display the current setting without changing the setting. In one embodiment, Back 350 is adapted for toggling the Home and Away modes. The first press of the Back 350 causes the display 370 to display the status of the Home and Away modes. According to one aspect, a user can only choose one of the Home and Away modes, or deactivate both modes. The second press will enable the Home mode and deactivate the Away mode. The third press will enable the Away mode and deactivate the Home mode. The fourth press will disable both modes. Then the cycle repeats from the second press above for each successive press. When the Back 350 has not been pressed for about 3 seconds, the display 370 reverts to time and day display.

In the custom mode, pressing Menu 310 button scrolls through the menu flow. The sequence of the menu flow displayed on the display 370 is Time/Day display, Timer A, Timer B, Motion, Photo, Set Time and back to Time/Day display. Pressing On/Off 360 button causes the light to be turned on or off and returns the device to the Time/Day display. Pressing Up 330 and Down 340 causes the device to return to the Time/Day display. Pressing Back 350 takes the device back to a previous displayed item. When the Time/Day display is on, the pressing of Back 350 button causes the device to revert to Home/Away mode. An Enter 320 button allows a user to change programming information for the displayed function such as Timer A, Timer B, Motion, Photo, Set Day/Time.

When pressing the Enter 320 button from a custom menu while Timer A, Timer B, Motion, or Photo is displayed on the display 370, the user will be asked to set the day for the alarm (All, Weekdays, Weekends or Off), start time for the alarm, the dimming level, and the end time of the alarm. If the user sets the day to Off, the user will not have to go through the rest of the function parameters. The user will be directed to the next custom function in the list. Using the menu key to continue to the desired function in the custom menu.

When pressing the Enter 320 button from the custom menu while Set Time is displayed on the display 370, the user will be asked to set the time of day for the real time clock and the day of the week it is such as Monday through Sunday. After setting the last item in each of these instances, the display 370 will show Set On. Pressing Enter 320 will take the device back to the Time/Day display.

The value changes of parameters such as day, time, and dimming can be achieved by pressing Up 330 and/or Down 340 in an appropriate sub-menu. Pressing the Back 350 causes the device to return to the previous parameter screen. If the Back 350 button is pressed all the way back to the custom menu, this will revert to its custom menu function. In this case, any changes made thus far to the custom program will be lost. Enter 320 is used to advance to the next programming option in the list after setting the current option. When all options have been programmed and Set OK is displayed, then the device returns to the Time/Day display.

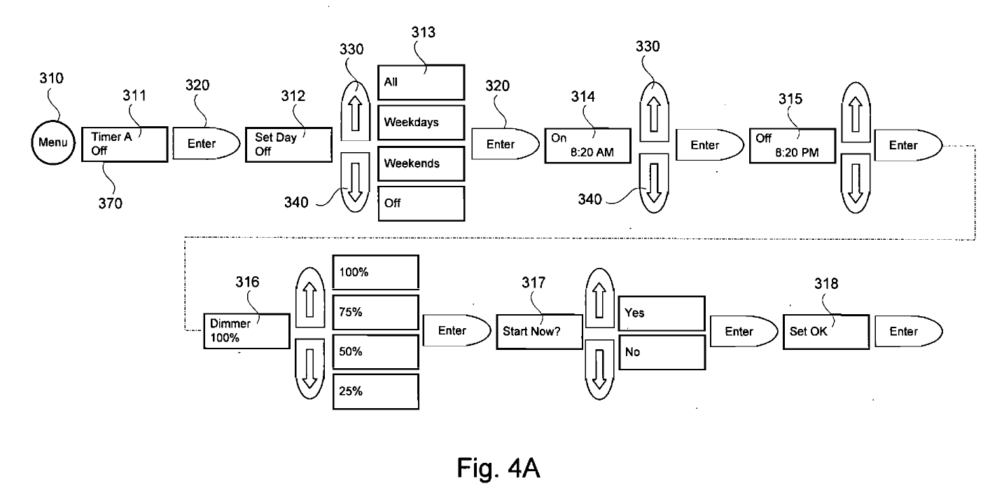

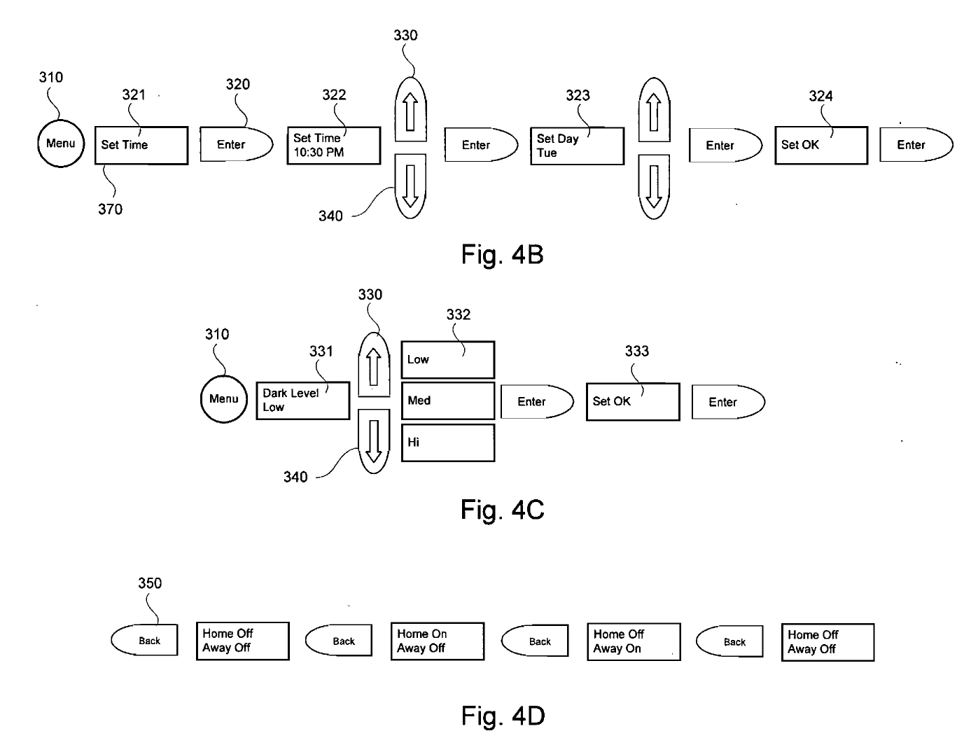

Referring to FIGS. 4A-D, certain setting or configuration procedures of the device 300 are shown according to one embodiment of the present invention. FIG. 4A illustrates the sequential steps of setting parameters for the first timer, Timer A. In the custom mode, sequentially pushing Menu 310 causes the display 370 to display one of default menu functions: Timer A Off, Timer B Off, Motion Off and Photo Off. When a message of “Timer A Off” 311 is prompted in the display 370, pushing Enter 320, which sets up Timer A, causes “Set Day Off” 312 to be displayed in the display 370. Then Up 330 and Down 340 pushbuttons are used to select a desired setting, such as All, Weekdays, Weekends, or Off, as shown in exemplary display screens 313. For example, if the desired setting is for weekdays, pushing Enter 320 will set Timer A for weekdays when the display 370 displays the massage of “Weekdays” 313. Afterwards, a message of “On 8:20 AM” 314, for example, will be prompted in the display 370, which is the time to activate the Timer A during the weekdays. The activation time can be changed by pushing Up 330 and/or Down 340. Once a desired time is prompted up on the display 370, pushing Enter 320 will set the Timer A to be activated at the desired time. Then a message of “Off 8:20 PM” 315 is prompted on the display 370, which is a deactivation time of the Timer A during the weekdays. Again, the deactivating time can be changed by pushing Up 130 and/or Down 340, and then Enter 320.

Another aspect of the invention involves setting of a predetermined dimming level for power to the load. According to one embodiment, after setting the “off” time as in the preceding paragraph a message of “Dimmer 100%” 316 is displayed on the display 370. In this stage, a desired level of output power of the light (or load), for example, 100%, 75%, 50% or 25%, can be set by pushing Up 330 and/or Down 340, and Enter 320. Then, a message of “Start Now?” 317 is prompted on the display 370. Using Up 330 and/or Down 340, and Enter 320 to select “Yes” or “No”. When “Yes” is selected, the Timer A will be activated now rather than waiting until the clock gets all the way back around to the activation time (start time). Otherwise, when “No” is selected, the Timer A will be not activated until the activation time. Finally, a message of “Set OK” 318 is prompted on the display 370. Pushing Enter 320 will finish programming the Timer A.

Applying the above procedures, one can set up the second timer, Timer B, the motion sensor, and the photo sensor accordingly.

FIG. 4B illustrates the steps of setting up the current time and day for the device. First, the user presses Menu 340 until a message of “Set Time” 321 is displayed on the display 370, then presses Enter 320 causes a default time or a previous time setting, for example, “Set Time 10:30 PM” 322 to be prompted on the display 370. To set up the current time, the user can press Up 330 and/or Down 340 to change the default time to the current time, and push Enter 320. Then “Set Day TUE” 323 is displayed. Using UP 330 and/or Down 340, and Enter 320, the user can set the device to the current day. When “Set OK” 324 is prompted on the display 370, pushing Enter 320 will set up the Timer A accordingly.

FIG. 4C shows the sequential steps of setting up a predetermined threshold value of an ambient light level, according to another aspect of the invention. The user pushes Menu 340 sequentially until a message of “Dark Level” 331 is displayed on the display 370, then presses Up 330 and/or Down 340 to select a desired level, for example, Low, Med (medium), or Hi (high), and then presses Enter 320 to set up the level. When “Set OK” 333 is prompted on the display 370, pressing Enter 320 will set up the predetermined threshold value of the ambient light level accordingly. A predetermined “low” setting configures the microcontroller to activate operations at a lower ambient light level (e.g. to wait until it is darker before activating), while a predetermined “high” setting configures the microcontroller to activate at a higher light level (e.g. to activate before it is fully dark), while a predetermined “medium” level is in between low and high. It will also be appreciated that the microcontroller may be configured to provide for a selectably variable ambient light level, at values input by the user (with user screens and controls, not shown).

FIG. 4D shows the procedures of using Back 650 to select the Home or Away mode to be effective.

Additionally, the device has a manual mode having an ON state and an OFF state. The ON state and OFF state can be set up by an On/Off pushbutton 360. When the device operates in the ON state, it will transmit the power to the at least one load regardless of the environmental condition in the area. When the device operates in the OFF state, it will not transmit the power to the at least one load regardless of the environmental condition in the area.

In one embodiment of the present invention, the device is constructed with a printed circuit board (hereinafter “PCB”) with an embedded design having a programmable microcontroller. The PCB incorporates certain standard components, including a built in timer, On/Off switch, indicator LED, LCD, and reset switch. The central piece of the core design is an 8-bit PIC18F452 microcontroller, which comprises a main central processing unit (hereinafter “CPU”) controlling the entire circuit. The preferred microcontroller is a 40-pin device with 33 I/O ports, 100 million instructions per second (“MIPS”), and 1536 bytes of random access memory (“RAM”). Additionally, this controller utilizes flash memory technology for easy programmability and re-programmability. The 33 I/O ports are sufficient for the components, such as motion detector, photocell, timer, dimmer, LCD and user interface pushbuttons. Other types of microcontrollers and I/O ports can also be used to practice the present invention, and will be known to those skilled in the art. Details of the preferred microcontroller are available from the manufacturer of this particular type of microcontroller or its many equivalents.

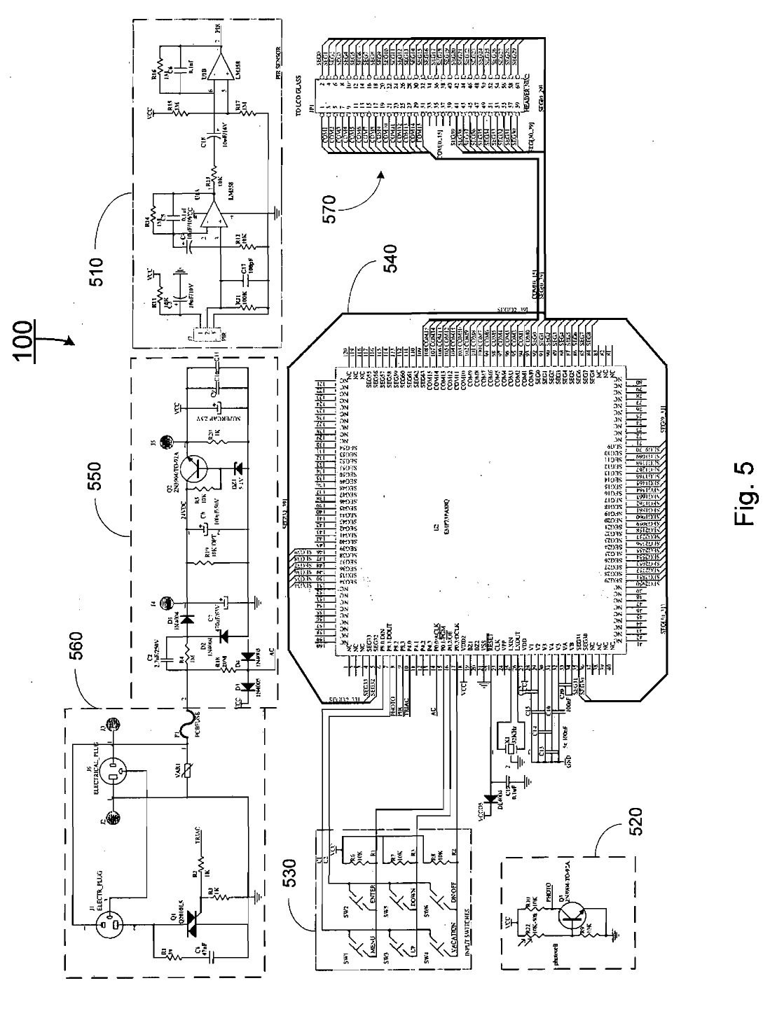

FIG. 5 is a circuit diagram of the device 100 according to one embodiment, where blocks 510 and 520 are circuit diagrams of a PIR sensor circuit and a photocell circuit, respectively. Block 530 is a circuit diagram of switches in the user interface of the device. Block 540 is a multi-pin microcontroller with multiple I/O ports. Block 550 is a circuit diagram of components that convert 110-120 VAC electrical power to a voltage level (VCC) for powering the circuit elements of the device including microcontroller, detectors, display, etc. Block 560 is a circuit diagram of an electronically controlled variable power electronic switching circuit such as a conventional triac that is responsive to a signal from the microcontroller to selectively switch power from a source of electrical power to an electrical load that is connected across the terminals of the triac, in the manner that will be known to those skilled in the art. Block 550 shows the electrical connections of a digital display of the user interface.

The PIR sensor 510 provides a signal PIR to the microcontroller 540 that represents detection of motion. The photocell 520 provides a signal PHOTO to the microcontroller 540 that represents ambient light level. The microcontroller provides an output signal TRIAC to the power switching circuit 560; the TRIAC signal controls the variable level switching of power to the electrical load for switching on and off and dimming at variable levels, in a manner that will be known to those skilled in the art.

In one embodiment, the motion sensor is a KC7783 PIR sensor module with a Fresnel lens and integrated circuit (“IC”) controller. The detection distance of the PIR is typically preset by the manufacturer, e.g. at 5 meters with 60° of detection angle. The voltage requirement range for the PIR is from 4 to 12 volts. This fits a 5-volt design specification required for the PIC by using a wall transformer to step the voltage down from 120 volts. The photocell is a Xicon 338-76C59 photo conductive cell having a fast switching time between high and low resistances for quickly responding to a light change, a dark resistance of 50 MΩ and a light resistance 50 kΩ, which provide a wide range to adequately distinguish different light levels. Codes, in terms of an assembler language, are loaded into the microcontroller, for encompassing programming the PIC, setting the LCD menus, setting photocell sensitivity, and coordinating the data from the input components, such as motion sensor, photocell, timer. Other types of motion sensors and photo sensors can also be utilized to practice the present invention.

One aspect of the present invention provides a method for selectively providing power from a source of power to at least one load to operate in an area. In one embodiment, the method includes the following steps: at a configuring step, a first detector is configured for generating a detection signal thereof responsive to an ambient light level being below the predetermined threshold value (e.g. a low light environmental condition), a second detector is configured for generating a motion signal thereof responsive to a movement in the area (e.g. a movement in the area condition), and a microcontroller, coupled to the first detector and the second detector, is configured for running various timers of various predetermined time periods and operatively controlling transmission of the source of power to the at least one load. The first detector is a light sensor, for example, a Xicon 338-76C59 photo conductive cell. The second detector is a motion sensor, such as a KC7783 pyroelectric passive infrared (PIR). A PIC18F452 microcontroller is employed according to one embodiment of the present invention.

At a programming step, a plurality of control parameters are programmed via a user interface in communication with a microcontroller. At an activating step, the light sensor is triggered to monitor the ambient light level when the first predetermined activation time passes, and the second detector is triggered to monitor movement in the area when the second predetermined activation time passes.

When one of the detection signal and the motion signal is generated or the predetermined power-on time passes, power is switched to the at least one load for a time period by the microcontroller. The time period is defined by the first predetermined duration of time if the triggering signal is the detection signal, by the second predetermined duration of time if the triggering signal is the motion signal, or by the third predetermined duration of time if the predetermined power-on time passes.

At a deactivating step, the light sensor is deactivated when the first predetermined deactivation time passes, and the motion sensor in deactivated when the second predetermined deactivation time passes.

In one embodiment, the microcontroller is further configured such that when switching the power is triggered by the low light detection signal, any subsequent one of a motion signal or expiration of the predetermined power-on time period generated during the first predetermined duration of time is ignored. Furthermore, when switching the power is triggered by the expiration of the predetermined power-on time period, any subsequent one of a low light detection signal or a motion signal generated during the third predetermined duration of time is ignored. Further still, when switching the power is triggered by the motion signal, any subsequent one of a low light detection signal or expiration of the predetermined power-on time period generated during the second predetermined duration of time is ignored, but a subsequent motion signal generated by the second detector during the time period renews the time period.

According to different embodiments of the present invention, a timer, a light sensor such as a photocell, and a motion sensor, alone or any combination thereof, can be utilized to selectively provide power from the source of power to a load to operate in an area responsive to an ambient condition in the area. Without intend to limit the scope of this invention, some flowcharts of the device in operation in various embodiments are respectively described as follows.

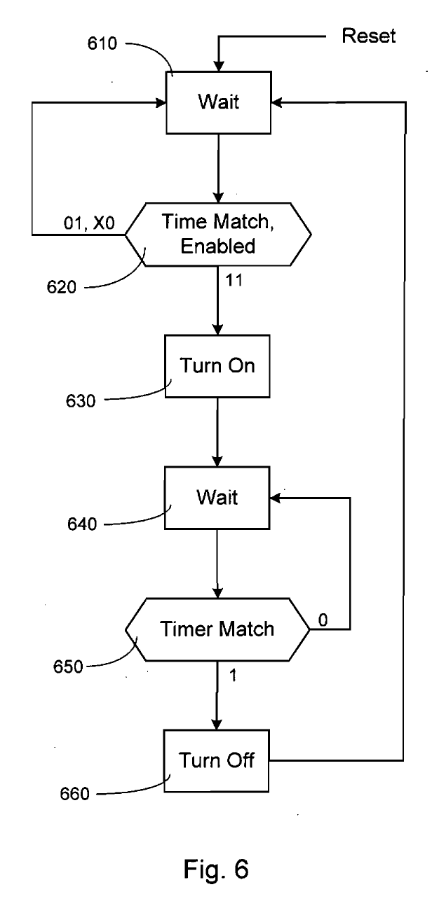

Referring now to FIG. 6, a flowchart of a timer controlling a source of power through a load, according to one embodiment of the present invention, is shown. At first, the timer is reset to a waiting mode (610). If the timer matches a predetermined power-on time period and is enabled/activated will trigger a next step. When the timer matches the predetermined power-on time and is enabled (620), a switching on (630) of the load will be triggered. Otherwise, the timer will be set in the waiting mode (610). When the light (load) is powered, the timer will be set in a waiting mode (640), and check whether a predetermined power-off time for the load has expired. When the timer matches the predetermined power-off time (650), a turn off (660) for the load will be triggered. Otherwise, the timer will be set in the waiting mode (640) until the timer matches the predetermined power-off time. If the power of the load is turned off (660), the timer will be set to the waiting mode (610).

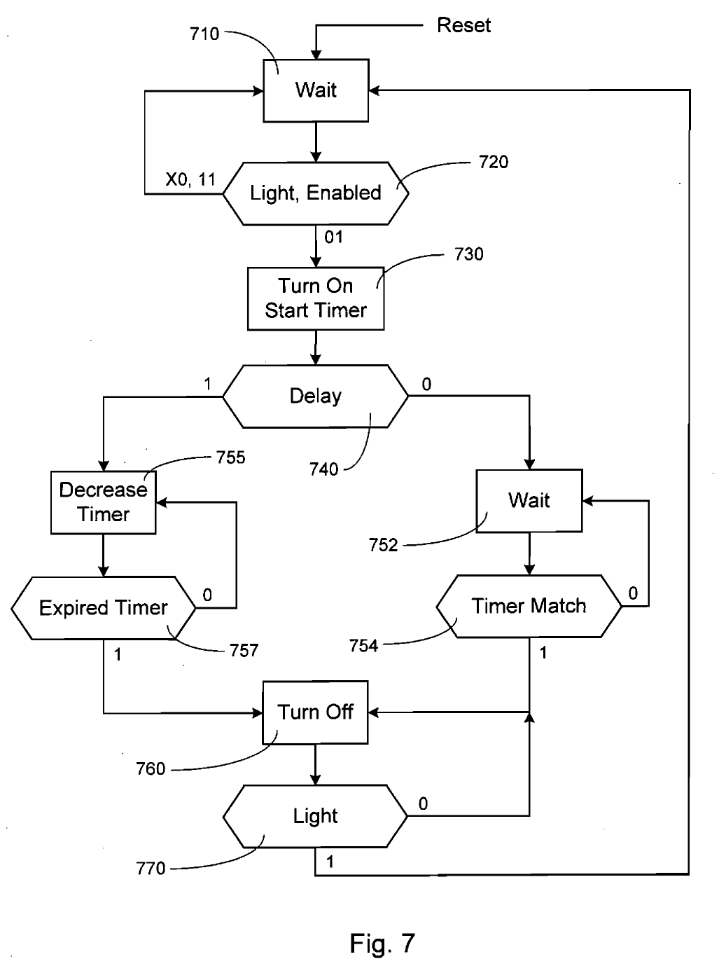

FIG. 7 shows a flowchart of a photocell in conjunction with a timer for selectively providing power from the source of power to a load to operate in an area responsive to an ambient light condition in the area. The photocell is first reset to a waiting mode (710). Then the ambient light condition and a status of the photocell determines a next step to be operated. When the ambient light level is below a predetermined threshold value and the photocell is enabled/activated (720), the load is triggered (switched) on and the timer is triggered to start counting time (730). If a power-on delay (740), or a predetermined duration of time, is set for the timer, the timer will count time decreasingly from the power-on delay (755), and the expiration of the power-on delay (757) will trigger step 470 to power off the load; otherwise, the timer will continue counting time of the power-on delay (755) until the expiration of the power-on delay. If no power-on delay (740) is set for the timer, the timer will be set in a waiting mode (752) and check whether a predetermined power-off time for the load has expired. When the timer matches the predetermined power-off time (754), a turn off (760) for the load will be triggered. Otherwise, the timer will be set in the waiting mode (752) until the timer matches the predetermined power-off time. When the power of the load is turned off (760), the photocell (770) is set to the waiting mode (710) if the ambient light level is above the predetermined threshold value; otherwise, the photocell (770) is set to a mode where the load is power off (760).

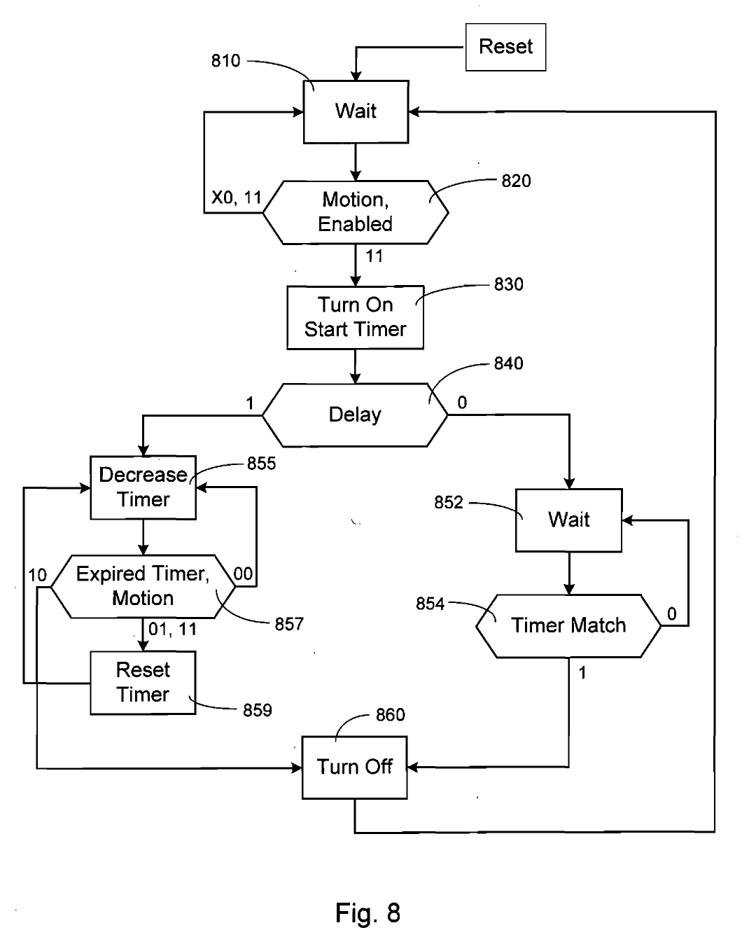

FIG. 8 shows a flowchart of a motion sensor in conjunction with a timer for selectively providing power from the source of power to a load to operate in an area responsive to motion in the area. The motion sensor is first reset to a waiting mode (810). An ambient condition and a status of the motion sensor will determine a next step to be operated. When the motion sensor is enabled/activated and motion is detected (820), the load switched on and the timer is triggered to start counting time (830). If a power-on delay (840), or a predetermined duration of time, is set for the timer, the timer will count time decreasingly from the power-on delay (855). Then, if no further motion is detected before the expiration of the power-on delay (857), the timer will continue counting time of the power-on delay (855). If no further motion is detected by the expiration of the power-on delay (857), the load will be switched off (860). Otherwise, if a further motion is detected by the expiration of the power-on delay (857), the timer will be reset (859) to renew the power-on delay (855).

If no power-on delay (840) is set for the timer, the timer will be set in a waiting mode (852) and check whether a predetermined power-off time for the load has expired (854). When the timer matches the predetermined power-off time (854), a turn off (860) for the load will be triggered. Otherwise, the timer will be set in the waiting mode (852) until the timer matches the predetermined power-off time.

When the power of the load is turned off (860), the motion sensor is set to the waiting mode (810).

In summary, the present invention, among other things, provides a device connected between a source of power and at least one load for selectively providing power from the source of power to the at least one load to operate in an area responsive to an environmental condition in the area.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A device connected between a source of power and at least one load for selectively providing power from the source of power to the at least one load to operate in an area responsive to an environmental condition in the area, wherein the environmental condition in the area comprises at least one event including an ambient light level being below a predetermined threshold value, movement in the area, and expiration of a predetermined power-on time period, comprising:
a. a home mode, configured so that the device operates in a way of which a plurality of control parameters are pre-programmed,
b. a custom mode, configured so that the device operates in a way of which a plurality of control parameters are programmable; and
c. a user interface for selecting one of the home mode and the custom mode to be operated,
wherein the plurality of control parameters comprises the predetermined threshold value, a first predetermined activation time, a second predetermined activation time, a first predetermined deactivation time, a second predetermined deactivation time, a first predetermined duration of time, a second predetermined duration of time, a third predetermined duration of time, and the predetermined power-on time.

2. The device of claim 1, further comprising
a. at least one timer for timing a plurality of predefined operations;
b. a first detector for generating a low light detection signal responsive to an ambient light level being below the predetermined threshold value, the first detector being activated to monitor the ambient light level when the first predetermined activation time expires, and being deactivated when the first predetermined deactivation time expires;
c. a second detector for generating a motion signal responsive to detection of movement in the area, the second detector being activated to monitor the movement in the area when the second predetermined activation time expires, and being deactivated when the second predetermined deactivation time expires; and
d. a microcontroller coupled to the at least one timer, the first detector, and the second detector and associated with a user interface for operatively controlling transmission of the source of power to the at least one load, the microcontroller being configured such that when one of the detection signal and the motion signal is generated or the predetermined power-on time expires, power is coupled to the at least one load for a period of time, wherein the period of time is defined by the first predetermined duration of time if the signal is the low light detection signal, by the second predetermined duration of time if the signal is the motion signal, and by the third predetermined duration of time if the predetermined power-on time expires, respectively.

3. The device of claim 2, wherein the user interface comprises a plurality of pushbuttons and a display for displaying menus of selectable commands, wherein each pushbutton, in communication with the microcontroller, performs a predetermined function, and wherein each menu is associated with the plurality of pushbuttons.

4. The device of claim 3, wherein the display comprises a liquid crystal display (LCD) or a light emitting diode (LED) display.

5. The device of claim 2, wherein the first detector comprises a light sensor.

6. The device of claim 2, wherein the second detector comprises a motion sensor.

7. The device of claim 1, further comprising a manual mode having an ON state and an OFF state, the ON state causing the power to be transmitted to the at least one load regardless of the environmental condition in the area, and the OFF state causing the power not to be transmitted to the at least one load regardless of the environmental condition in the area.

8. A device connected between a source of power and at least one load for selectively providing power from the source of power to the at least one load to operate in an area responsive to an environmental condition in the area, comprising:
a. at least one timer for timing a plurality of predefined operations;
b. a first detector for generating a low light detection signal responsive to an ambient light level being below a predetermined threshold value, the first detector being activated to monitor the ambient light level when a first predetermined activation time expires, and being deactivated when a first predetermined deactivation time expires;
c. a second detector for generating a motion signal responsive to detection of movement in the area, the second detector being activated to monitor the movement in the area when a second predetermined activation time expires, and being deactivated when a second predetermined deactivation time expires;
d. a microcontroller coupled to the first detector and the second detector for operatively controlling switching of power to the at least one load, the microcontroller being configured such that when one of the low light detection signal and the motion signal is generated or a predetermined power-on time expires, the power is transmitted to the at least one load for a period of time, wherein the period of time is defined by a first predetermined duration of time if the signal is the low light detection signal, by a second predetermined duration of time if the signal is the motion signal, and by a third predetermined duration of time if the predetermined power-on time expires, respectively; and
e. a user interface coupled to the microcontroller for programmably configuring a plurality of control parameters, the plurality of control parameters comprising the predetermined threshold value, the first predetermined activation time, the second predetermined activation time, the first predetermined deactivation time, the second predetermined deactivation time, the first predetermined duration of time, the second predetermined duration of time, the third predetermined duration of time, and the predetermined power-on time.

9. The device of claim 8, wherein the microcontroller is further configured such that:
a. when switching of power is triggered by the low light detection signal, any subsequent one of a motion signal or expiration of the predetermined power-on time period generated during the first predetermined duration of time is ignored;
b. when switching of power is triggered by the motion signal, any subsequent one of a low light detection signal or expiration of the predetermined power-on time period generated during the second predetermined duration of time is ignored, but a subsequent motion signal generated by the second detector during the time period triggers to renew the time period; and
c. when switching of the power is triggered by the expiration of the predetermined power-on time period, any subsequent one of a low light detection signal or a motion signal generated during the third predetermined duration of time is ignored.

10. The device of claim 9, wherein the user interface comprises a plurality of pushbuttons and at least one display for displaying a menu of selectable commands, wherein each pushbutton, in communication with the microcontroller, performs a predetermined function, and wherein each menu is associated with the plurality of pushbuttons.

11. The device of claim 10, wherein the at least one display comprises a liquid crystal display (LCD) or a light emitting diode (LED) display.

12. The device of claim 8, wherein the user interface comprises a touch screen having a plurality of settings, each setting including icons, each icon corresponding to a predetermined function that is communicated to the microcontroller to cause the device to perform a predefined operation.

13. The device of claim 12, wherein the touch screen comprises a liquid crystal display (LCD) or a light emitting diode (LED) display.

14. The device of claim 8, wherein the first detector comprises a light sensor.

15. The device of claim 8, wherein the second detector comprises a motion sensor.

16. A method for selectively providing power from a source of power to at least one load to operate in an area responsive to an environmental condition in the area, comprising of the steps of:
a. configuring a first detector for generating a low light detection signal responsive to an ambient light level being below a predetermined threshold value, a second detector for generating a motion signal responsive to movement in the area, and a microcontroller coupled to the first detector and the second detector for operatively controlling switching of power to the at least one load, respectively;
b. programming a plurality of control parameters with a user interface communicating with a microcontroller, wherein the plurality of control parameters comprises the predetermined threshold value of a light level, a first predetermined activation time, a second predetermined activation time, a first predetermined deactivation time, a second predetermined deactivation time, a first predetermined duration of time, a second predetermined duration of time, a third predetermined duration of time, and a predetermined power-on time;
c. activating the first detector to monitor an ambient light level when the first predetermined activation time expires, and the second detector to monitor a movement in the area when the second predetermined activation time expires, respectively;
d. switching power to the at least one load for a period of time by a microcontroller when one of the low light detection signal and the motion signal is generated or the predetermined power-on time expires, wherein the period of time is defined by the first predetermined duration of time if the signal is the low light detection signal, by the second predetermined duration of time if the signal is the motion signal, and by the third predetermined duration of time if the predetermined power-on time expires, respectively; and
e. deactivating the first detector when the first predetermined deactivation time expires, and the second detector when the second predetermined deactivation time expires, respectively.

17. The method of claim 16, wherein the microcontroller is further configured such that:
a. when transmission of the power is triggered by the low light detection signal, any subsequent one of a motion signal or expiration of the predetermined power-on time period generated during the first predetermined duration of time is ignored;
b. when transmission of the power is triggered by the motion signal, any subsequent one of a low light detection signal and expiration of the predetermined power-on time period generated during the second predetermined duration of time is ignored, but a subsequent motion signal generated by the second detector during the time period triggers to renew the time period; and
c. when transmission of the power is triggered by the expiration of the predetermined power-on time period, any subsequent one of a low light detection signal or a motion signal generated during the third predetermined duration of time is ignored.

18. The method of claim 16, wherein the first detector comprises a light sensor.

19. The method of claim 16, wherein the second detector comprises a motion sensor.

20. The method of claim 16, wherein the user interface comprises a touch screen having a plurality of settings, each setting including icons, each icon corresponding to a predetermined function that is communicated to the microcontroller to cause the device to perform a predefined operation

21. The method of claim 20, wherein the touch screen comprises a liquid crystal display (LCD) or a light emitting diode (LED) display.

22. A device connected between a source of power and at least one load for selectively providing power from the source of power to the at least one load to operate in an area responsive to an environmental condition in the area, wherein the environmental condition in the area comprises one or more events including an ambient light level being below a predetermined threshold value and movement in the area, comprising:
a. a home mode being configured to allow the device to operate in a pre-programmed manner such that
i). when the ambient light level is above the predetermined threshold value, the device is powered off, and a detected signal of motion will trigger the device to be power on with a full amount of power for a predetermined period of time, thereafter, the device is powered off if no motion is detected during the predetermined period of time; and
ii). when the ambient light level is below the predetermined threshold value, the device is powered on with a predetermined reduced amount of power, and a detected signal of motion will trigger the device to be power on with a full amount of power for a first predetermined period of time; if no further motion is detected during the first predetermined period of time, the device reduces power to the predetermined reduced amount of power for a second predetermined period of time, and if no further motion is detected during the second predetermined period of time, the device is powered off; and
b. an away mode being configured such that the ambient light level is below the predetermined threshold value, the device is powered on and off at random times.

23. The device of claim 22, further comprising a custom mode being configured to allow the device to operate in a way of which a plurality of functions are programmable.

24. The device of claim 23, further comprising a user interface for selectively operating the device in one of the home mode, the away mode, and the custom mode.

25. The device of claim 22, wherein further comprising a dimmer for adjusting the power supplied to the at least one load at a predetermined level.

26. The device of claim 22, wherein the home mode is further configured such that when the ambient light level is above the predetermined threshold value, the device is powered off and movement in the area is ignored.

27. A device connected between a source of power and at least one load for selectively providing power from the source of power to the at least one load to operate in an area, comprising:
a. a dimmer for adjusting the power supplied to the at least one load thereof responsive to an environmental condition in the area,
wherein the environmental condition in the area comprises a plurality of events including an ambient light level being below a predetermined threshold value, movement in the area, and expiration of a predetermined power-on time period.

28. The device of claim 27, further comprising a photo detector for generating a low light detection signal responsive to an ambient light level being below a predetermined threshold value in the area.

29. The device of claim 28, further comprising a motion detector for generating motion signal responsive to detection of a movement in the area.

30. The device of claim 29, further comprising a microcontroller coupled to the dimmer, the photo detector, and the motion detector for programmably controlling switching of the source of power to the at least one load responsive to the low light detection signal and the motion signal.

31. A device connected between a source of power and at least one load for selectively providing power from the source of power to the at least one load to operate in an area responsive to an environmental condition in the area, wherein the environmental condition in the area comprises one or more events including an ambient light level being below a predetermined threshold value and movement in the area, comprising:
a. a programmed microcontroller;
b. an electronic switch coupled to the microcontroller for providing power from the source of power to the load at variable levels in response to signals from the microcontroller;
c. a light detector coupled to the microcontroller operative to detect ambient light level in the area;
d. a motion detector coupled to the microcontroller operative to detect motion in the area;
e. the microcontroller operative such that when the ambient light level detected by the light detector is above a predetermined threshold value, the device is powered off, and motion detected by the motion detector motion will trigger the device to be power on with a full amount of power for a predetermined period of time, thereafter, the device is powered off if no motion is detected during the predetermined period of time; and
f. the microcontroller further operative such that when the ambient light level detected by the light detector is below the predetermined threshold value, the device is powered on with a predetermined reduced amount of power, and a detected signal of motion will trigger the device to be power on with a full amount of power for a first predetermined period of time; if no further motion is detected during the first predetermined period of time, the device reduces power to the predetermined reduced amount of power for a second predetermined period of time, and if no further motion is detected during the second predetermined period of time, the device is powered off.
